(19) United States
(12) Patent Application Publication
(10) Pub. No.: US 2021/0053286 A1
(43) Pub. Date: Feb. 25, 2021

(54) DEFLECTION RESTRAINT SYSTEM FOR BUILD PLATE IN ADDITIVE MANUFACTURING

(71) Applicant: Applied Materials, Inc., Santa Clara, CA (US)

(72) Inventors: Joseph Yudovsky, Campbell, CA (US); John Rusconi, Dublin, CA (US); Mahendran Chidambaram, Saratoga, CA (US)

(21) Appl. No.: 16/546,194

(22) Filed: Aug. 20, 2019

(51) Int. Cl. B29C 64/245; B33Y 30/00; B29C 64/295; B22F 3/105; B28B 1/00

(52) U.S. Cl. CPC B29C 64/245; B33Y 30/00; B22F 2003/1056; B22F 3/1055; B28B 1/001; B29C 64/295

(57) ABSTRACT

A build plate assembly for an additive manufacturing apparatus includes a build plate to support an object to be fabricated by successive delivery of a plurality of layers of powder, a support structure beneath the build plate and separated from the build plate by one or more supports, and a plurality of restraints securing an outer edge of the build plate to the support structure.

### TECHNICAL FIELD

This specification relates to additive manufacturing, also known as 3D printing.

### BACKGROUND

Additive manufacturing (AM), also known as solid freeform fabrication or 3D printing, refers to a manufacturing process where three-dimensional objects are built up from successive dispensing of raw material (e.g., powders, liquids, suspensions, or molten solids) into two-dimensional layers. In contrast, traditional machining techniques involve subtractive processes in which objects are cut out from a stock material (e.g., a block of wood, plastic, composite, or metal).

A variety of additive processes can be used in additive manufacturing. Some methods melt or soften material to produce layers, e.g., selective laser melting (SLM) or direct metal laser sintering (DMLS), selective laser sintering (SLS), or fused deposition modeling (FDM), while others cure liquid materials using different technologies, e.g., stereolithography (SLA).

These processes can differ in the way layers are formed to create the finished objects and in the materials that are compatible for use in the processes.

In some forms of additive manufacturing, a powder is placed on a platform and a laser beam traces a pattern on the powder to fuse the powder in a region to form a layer of the part. Once the region is fused, the platform is lowered and a new layer of powder is added.

The process is repeated until a part is fully formed.

### SUMMARY

In one aspect, a build plate assembly for an additive manufacturing apparatus includes a build plate to support an object to be fabricated by successive delivery of a plurality of layers of powder, a support structure beneath the build plate and separated from the build plate by one or more supports, and a plurality of restraints securing an outer edge of the build plate to the support structure.

In another aspect, a build plate assembly for an additive manufacturing apparatus includes a build plate to support an object being fabricated by successive delivery of a plurality of layers of powder, and a support structure beneath the build plate and separated from the build plate by a plurality of supports. The plurality of supports are situated in a plurality of recesses, and the plurality of recesses include one or more first recess each of which permits motion of an associated support along two perpendicular directions and a second recess that limits movement of an associated support to a single direction along an axis that passes through the center of the build plate.

In another aspect, an additive manufacturing system includes a build plate assembly, a dispenser to deliver a succession of layers of powder onto the build plate, and an energy source to fuse a portion of an exposed layer of powder on the build plate.

Implementations can include one or more of, but are not limited to, the following advantages. Deformation of the build plate due to thermal expansion can be reduced. As a result, layers can be deposited with greater planarity, thus improving part yield and quality. thickness uniformity.

The details of one or more implementations are set forth in the accompanying drawings and the description. Other features, aspects, and advantages of the subject matter will become apparent from the description, the drawings, and the claims.

### BRIEF DESCRIPTION OF THE DRAWINGS

FIG. 1 is a schematic side view of an example additive manufacturing apparatus.

FIGS. 2A and 2B are schematic side and top views of a printhead from the additive manufacturing apparatus.

FIG. 3 is a schematic perspective view, partially cross-sectional, of a build plate from an additive manufacturing process.

FIG. 4 is a schematic top view of supports in a support structure.

### DETAILED DESCRIPTION

In many additive manufacturing processes, the temperature of a powder needs to be raised, for example, as part of a sintering or pre-heating process. However, raising the temperature of a build plate that supports the powder can lead to deformation of the build plate. This deformation can be caused by non-uniform heat distribution resulting in non-uniform thermal expansion of the build plate. For example, heat will dissipate faster from the edges of the build plate, so that more heat is retained at the center of the build plate. In addition, heat can dissipate from the top of the build plate so that the build plate is hotter at the bottom. This can cause the edges of the build plate to rise vertically relative to the center of the build plate. If the build plate is deformed due to thermal expansion, it can cause a build object on the build plate to warp or deform. In particular, a goal is to place and level a thin layer, e.g., 40 to 60 micron thickness, of powder. If the warpage of the build plate exceeds the layer thickness by a substantial amount making, leveling of the layer with a leveling blade becomes difficult.

One solution to maintaining a flat build plate at raised temperatures is to restrain the edges of the build plate to counter and limit the deformation. For example, multiple restraints positioned along the perimeter of the build plate can clamp the build plate to an underlying rigid support structure.

### Additive Manufacturing Apparatus

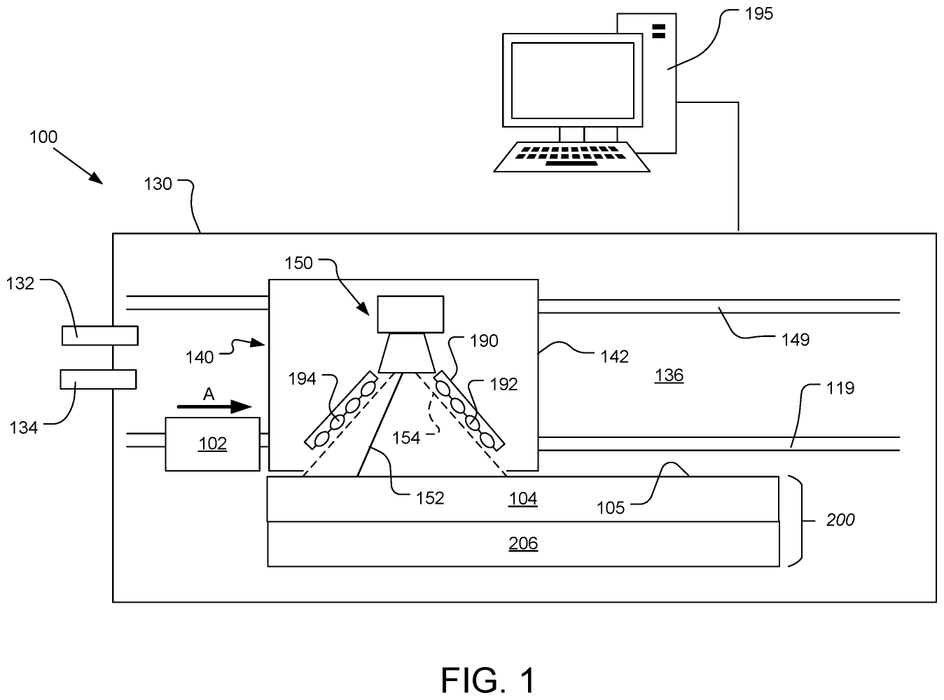

FIG. 1 illustrates a schematic side view of an example additive manufacturing (AM) apparatus 100 that includes a printhead 102 and a build plate assembly 200 (e.g., a build stage or platform) that includes a build plate 104 and a support structure 206. The printhead 102 dispenses layers of one or more powders on a top surface 105 of the build plate 104. By repeatedly dispensing and fusing layers of powder, the apparatus 100 can form a part on the platform.

The printhead 102 and the build plate 104 can both be enclosed in a housing 130 that forms a sealed chamber 136, e.g., a vacuum chamber, that allows for the removal of atmospheric gasses and provides isolation for a controlled operating environment. The chamber 136 can include an inlet 132 coupled to a gas source and an outlet 134 coupled to an exhaust system, e.g., a pump. The gas source can provide an inert gas, e.g. Ar, or a gas that is non-reactive at the temperatures reached by the powder for melting or sintering, e.g., N₂. This permits the pressure and oxygen content of the interior of the housing 130 to be controlled. For example, oxygen gas can be maintained at a partial pressure below 0.01 atmospheres.

The chamber 136 may be maintained at atmospheric pressure (but at less than 1% oxygen) to avoid the cost and complexity of building a fully vacuum compatible system. Oxygen content can be below 50 ppm when the pressure is at 1 atmosphere, e.g., when dealing with Ti powder particles.

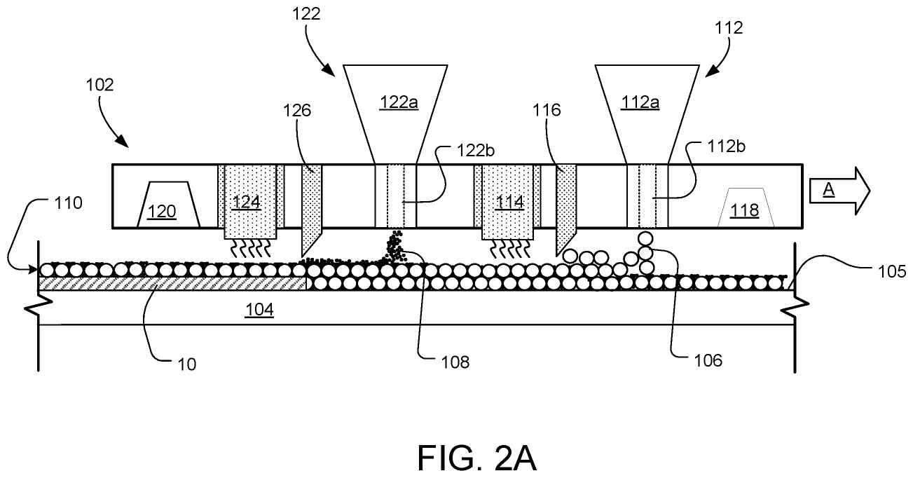

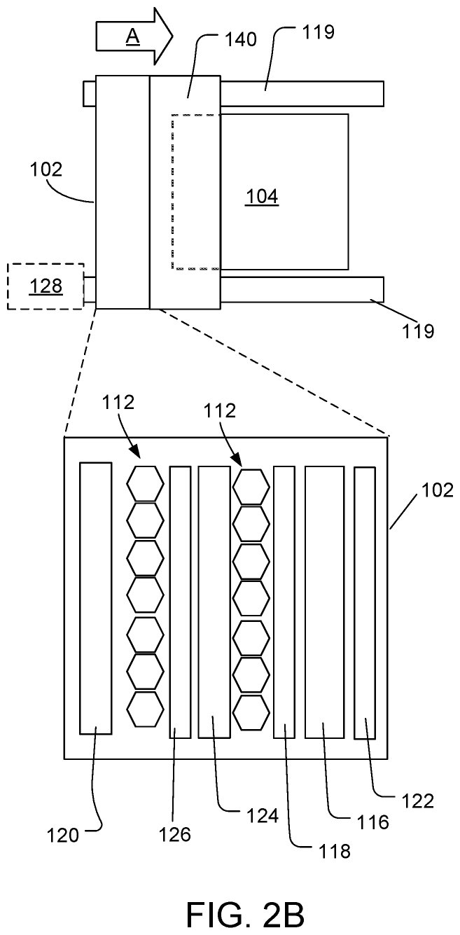

Referring to FIGS. 1 and 2B, the printhead 102 is configured to traverse the build plate 104 (shown by arrow A). For example, the apparatus 100 can include a support, e.g., a linear rail or pair of linear rails 119, along which the printhead can be moved by a linear actuator and/or motor. This permits the printhead 102 to move across the build plate 104 along a first horizontal axis. In some implementations, the printhead 102 can also move along a second horizontal axis perpendicular to the first axis.

The printhead 102 can also be movable along a vertical axis. In particular, after each layer is fused, the printhead 102 can be lifted by an amount equal to the thickness of the deposited layer 110 of powder. This can maintain a constant height difference between the dispenser on the printhead and the top of the powder on the build plate 104. A drive mechanism, e.g., a piston or linear actuator, can be connected to the printhead or support holding the printhead to control the height of the printhead. Alternatively, the printhead 102 can be held in a fixed vertical position, and the build plate assembly 200 can be lowered after each layer is deposited.

Referring to FIGS. 2A and 2B, the printhead 102 includes at least a first dispenser 112 to selectively dispense a layer 110 of a powder 106 on the build plate 104, e.g., directly on the build plate 104 or on a previously deposited layer. In the implementation illustrated in FIG. 2A, the first dispenser 112 includes a hopper 112a to receive the powder 106. The powder 106 can travel through a channel 112b having a controllable aperture, e.g., a valve, that controls whether the powder is dispensed onto the platform 104. In some implementations, the first dispenser 112 includes a plurality of independently controllable apertures, so that the powder can be controllably delivered along a line perpendicular to the direction of travel A.

Optionally, the printhead 102 can include a heater 114 to raise the temperature of the deposited powder. The heater 114 can heat the deposited powder to a temperature that is below its sintering or melting temperature. The heater 114 can be, for example, a heat lamp array. The heater 114 can be located, relative to the forward moving direction of the printhead 102, behind the first dispenser 112. As the printhead 102 moves in the forward direction, the heater 114 moves across the area where the first dispenser 112 was previously located.

Optionally, the printhead 102 can also include a first spreader 116, e.g., a roller or blade, that cooperates with first the dispensing system 112 to compact and spread powder dispensed by the first dispenser 112. The first spreader 116 can provide the layer with a substantially uniform thickness. In some cases, the first spreader 116 can press on the layer of powder to compact the powder.

The printhead 102 can also optionally include a first sensing system 118 and/or a second sensing system 120 to detect properties of the layer before and/or after the powder has been dispensed by the dispensing system 112.

In some implementations, the printhead 102 includes a second dispenser 122 to dispense a second powder 108. The second dispenser 122, if present, can be constructed similarly with a hopper 122a and channel 122b. A second spreader 126 can operate with the second dispenser 122 to spread and compact the second powder 108. A second heater 124 can be located, relative to the forward moving direction of the printhead 102, behind the second dispenser 122.

The first powder particles 106 can have a larger mean diameter than the second particle particles 108, e.g., by a factor of two or more. When the second powder particles 108 are dispensed on a layer of the first powder particles 106, the second powder particles 108 infiltrate the layer of first powder particles 106 to fill voids between the first powder particles 106. The second powder particles 108, being smaller than the first powder particles 106, can achieve a higher resolution, higher pre-sintering density, and/or a higher compaction rate.

Alternatively or in addition, if the apparatus 100 includes two types of powders, the first powder particles 106 can have a different sintering temperature than the second powder particles. For example, the first powder can have a lower sintering temperature than the second powder. In such implementations, the energy source 114 can be used to heat the entire layer of powder to a temperature such that the first particles fuse but the second powder does not fuse.

In implementations when multiple types of powders are used, the first and second dispensers 112, 122 can deliver the first and the second powder particles 106, 108 each into different selected areas, depending on the resolution requirement of the portion of the object to be formed.

Examples of metallic particles include metals, alloys and intermetallic alloys. Examples of materials for the metallic particles include titanium, stainless steel, nickel, cobalt, chromium, vanadium, and various alloys or intermetallic alloys of these metals. Examples of ceramic materials include metal oxide, such as ceria, alumina, silica, aluminum nitride, silicon nitride, silicon carbide, or a combination of these materials.

In implementations with two different types of powders, in some cases, the first and second powder particles 106, 108 can be formed of different materials, while, in other cases, the first and second powder particles 106, 108 have the same material composition. In an example in which the apparatus 100 is operated to form a metal object and dispenses two types of powder, the first and second powder particles 106, 108 can have compositions that combine to form a metal alloy or intermetallic material.

The processing conditions for additive manufacturing of metals and ceramics are significantly different than those for plastics. For example, in general, metals and ceramics require significantly higher processing temperatures. Thus 3D printing techniques for plastic may not be applicable to metal or ceramic processing and equipment may not be equivalent. However, some techniques described here could be applicable to polymer powders, e.g. nylon, ABS, polyetheretherketone (PEEK), polyetherketoneketone (PEKK) and polystyrene.

Returning to FIG. 1, the apparatus 100 also includes powder fusing assembly 140 that can translate across the build plate 104. The powder fusing assembly 140 includes at least one energy delivery system 150, e.g., a laser or electron gun, that can generate at least one beam 152, e.g., a light beam or electron beam, that is directed toward the uppermost layer of powder on the build plate 104 and that can be used at least for fusing of the layer of powder on the build plate 104. The beam 152 and/or another beam can be used for pre-heating and/or heat-treating the layer of powder.

As noted above, the powder fusing assembly 140 can translate across the build plate 104. For example, the apparatus 100 can include a support, e.g., a linear rail or pair of linear rails 149, along which the powder fusing assembly 140 can be moved by a linear actuator and/or motor. In some implementations, the printhead 102 and the powder fusing assembly 140 are independently movable. In some implementations, the powder fusing assembly 140 can translate along the same direction (e.g., shown by arrow A) as the printhead 102. Alternatively, the powder fusing assembly 140 can translate along a horizontal direction perpendicular to direction travelled by the printhead.

In some implementations, the printhead 102 and powder fusing assembly 140 are supported by and movable on the same support, e.g., the linear rail or pair of linear rails 119. In some implementations, the printhead 102 and the powder fusing assembly 140 are physically connected (see FIG. 2B) in a fixed position relative to each other. In this case, the printhead 102 and powder fusing assembly 140 move together, e.g., by the same actuator or motor.

In some implementations, the printhead 102 and the powder fusing assembly 140 are mechanically coupled to the same vertical actuator such that both are movable up or down together. This permits the dispenser(s) and any beam scanner(s) of the powder fusing assembly to maintain a constant distance from the uppermost layer of powder on a layer-by-layer basis.

Referring to FIG. 1, the powder fusing assembly 140 can include a frame 142 to which various components, e.g., components of the energy delivery system 150, are secured. In some implementations, the printhead 102 is secured to the frame 142. Although FIG. 1 illustrates the frame 142 as a closed housing, this is not necessary; the frame could simply be an open framework sitting within the housing 130.

The powder fusing assembly 140 includes an open volume 144 that extends from the surface 105 of the build plate 104 to the optical components of the energy delivery system 150. The open volume 144 at least encompasses a field of view 154 of the energy delivery system 150, i.e., the region through which the light beam(s) 152 can sweep to scan the layer 110 of powder.

The energy delivery system 150 includes at least one light source to generate at least one light beam 152 and at least one reflector assembly to scan the light beam 152 on the layer 110 of powder.

Referring to FIGS. 1, the powder fusing assembly 140 can also include a heat source 190. The heat source 190 can be used for pre-heating and/or heat treatment of the layer. The heat source 190 can include at least one array of heat lamps 192, e.g., infra-red lamps. For example, the heat source 190 can include a first array 192a of heat lamps positioned to illuminate a region before a linear scan region below the energy delivery system 150 to provide pre-heating of the layer 110, and a second array 192b of heat lamps positioned to illuminate a region after the linear scan region below the energy delivery system 150 to provide heat-treatment of the layer 110.

Each array of heat lamps 192 can be arranged along a plane that oblique relative to the top surface 105 of the build plate 104. This permits the heat lamps 192 to sit outside the field of view 154 of the energy delivery system 150.

The apparatus 100 includes a controller 195 coupled to the various components of the apparatus, e.g., power sources for the light sources and heaters, actuators and/or motors to move the printhead 102 and powder fusing assembly 140, actuators and/or motors for the components, e.g., dispensers and beam scanners, within the printhead 102 and powder fusing assembly 140, etc., to cause the apparatus to perform the necessary operations to fabricate an object.

The controller 195 can include a computer aided design (CAD) system that receives and/or generates CAD data. The CAD data is indicative of the object to be formed, and, as described herein, can be used to determine properties of the structures formed during additive manufacturing processes. Based on the CAD data, the controller 195 can generate instructions usable by each of the systems operable with the controller 195, for example, to dispense the powder 106, to fuse the powder 106, to move various systems of the apparatus 100, and to sense properties of the systems, powder, and/or the object 10. In some implementations, the controller 195 can control the first and second dispensing systems 112, 122 to selectively deliver the first and the second powder particles 106, 108 to different regions.

The controller 195, for example, can transmit control signals to drive mechanisms that move various components of the apparatus. In some implementations, the drive mechanisms can cause translation and/or rotation of these different systems, including. Each of the drive mechanisms can include one or more actuators, linkages, and other mechanical or electromechanical parts to enable movement of the components of the apparatus.

### Build Plate Support

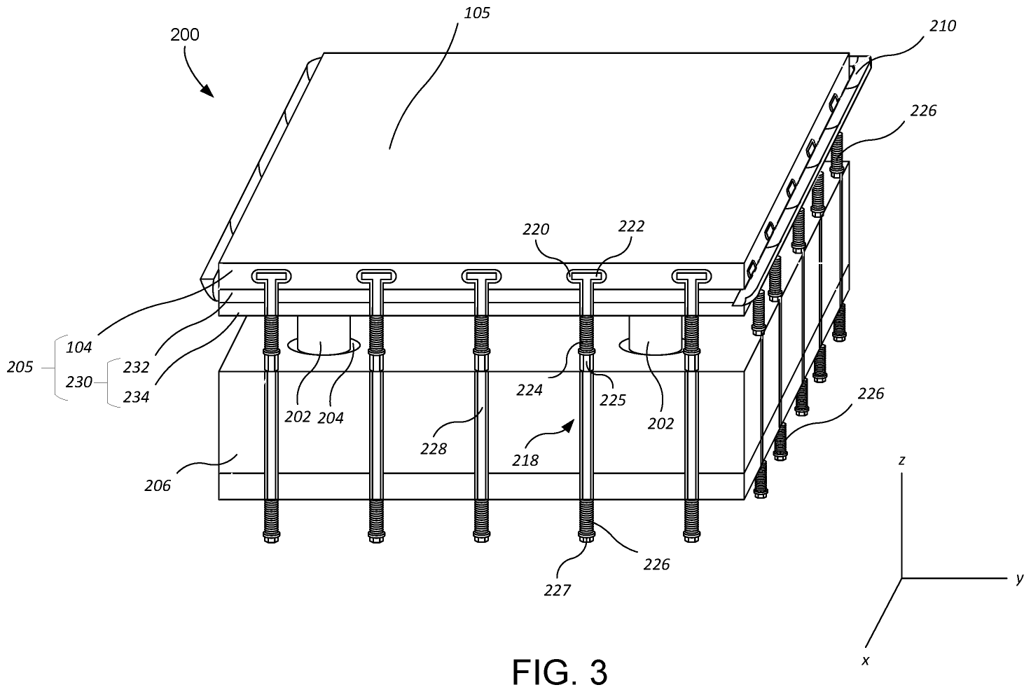

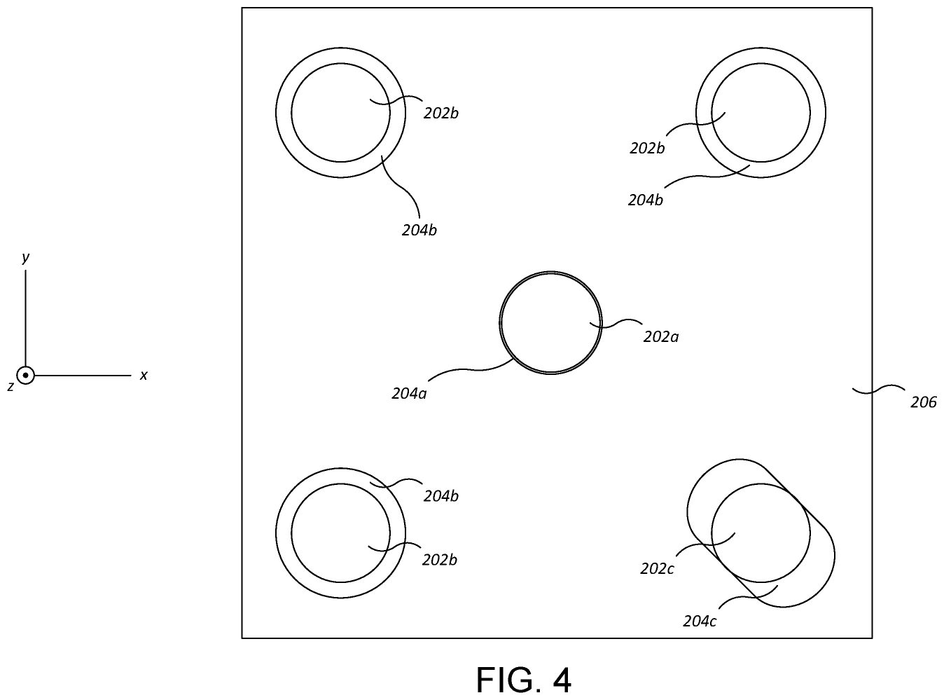

Referring to FIGS. 3 and 4, a build plate assembly 200 that includes the build plate 104 can be supported above the support structure 206 by one or more supports 202. The build plate assembly 200 can be spaced apart from the support structure 206, with the only conductive thermal contact through the supports 202. The supports 202 need to be large enough to support the load of the build plate assembly 200, but otherwise should be as small as possible to reduce heat transfer from the build plate 104 and the support structure 206. In addition, the horizontal cross sections of the one or more supports 202 used to separate the build plate 104 from the support structure 206 are small enough to limit heat transfer from the build plate 104 to the support structure 206. The supports 202 and support structure 206 can be stainless steel.

The one or more supports 202 can include a central support 202a positioned centrally located beneath the build plate assembly 200. Additionally, outer supports 202b, 202c can be placed around the centrally located support 202a. Although FIG. 4 illustrates the supports 202 as circular, other cross-sectional shapes are possible.

The supports 202 can be situated with lower ends that sit in recesses 204 in a top surface of the support structure 206. The recesses 204 allows movement of the supports 202 over the support structure 206, and thus for expansion of the build plate 104 without applying significant stress on the build plate assembly due to the expansion. Although FIGS. 3 and 4 illustrate the support structure 206 as a rectangular body, this is not necessary. The support structure 206 could be H-shaped or some other shape that covers the regions where the recesses 204 are desired to be placed.

At least one of the supports 202, e.g., the central support 202a, is configured to restrain lateral movement of the whole of the build plate assembly 200, i.e., along an x-axis and a y-axis. For example, as shown in FIG. 4, the supports 202a sits tightly within the recesses 204a, with the recess 204a is approximately equal in diameter to the supports 202a, such that the recess 204a limits movement of the support 202a along the x-axis and the y-axis

Another of the supports 202, e.g., one of the outer supports 202c, is configured to limit rotation of the build plate assembly 200 about a z-axis, e.g., about the center support 202a. For example, the support 202c can sit in a recess 204c that allows for movement of the support 202c (e.g., due to thermal expansion of the build plate 104) along a single direction (e.g., along the major axis of the stadium as illustrated in FIG. 4). The recess 204c can be a linear track, or shaped to restrict movement of the support 202c along an axis that crosses through the center of the support structure 206.

A remainder of the supports 202, e.g., supports 202b, can serve to simply support the build plate assembly 200 while permitting the build plate 104 to expand or contract due to thermal effects. The supports 202b can sit in recesses 204b, where the recesses 204b have diameters wider than the supports 202b. As such, the supports 202b can move (e.g., due to thermal expansion of the build plate 104) within the recesses 204b.

In some implementations, the build plate assembly 200 includes a heater assembly 230 connected to an underside of the build plate 104. The heater assembly 230 can be configured to heat the build plate 104. The heater assembly 230 can include an upper heater plate 232 and a lower heater plate 234, with a heater element (not illustrated) sandwiched in-between the upper heater plate 232 and the lower heater plate 234. The heater element can be a resistive heater, a thermoelectric heat pump, a passage for flow of heated fluid, etc. The heater assembly 230 can heat the build plate 104 up to 500° C.

In some implementations, a gutter 210 surrounds the build plate 104. The gutter 210 can be secured to the edge or an underside of the build plate 104, and is configured to catch powder before it can fall past the outside of the heater assembly 230, the support structure 206, or any other component beneath the build plate 104.

### Deflection Restraint System

The apparatus also includes a deflection restraint system to limit thermal deformation of the build plate. A plurality of restraints 218 are spaced along the perimeter of the build plate 104 to clamp a perimeter portion of the build plate 104 to the support structure. There are a sufficient amount of restraints to on each side of the build plate 104 to assure an even pressure around the edge of the build plate 104, e.g., the restraints 218 can be spaced at uniform interval around the perimeter of the build pate 104. There can be 4 to 40 restraints 218, For example, on a square build plate, there can be one to ten, e.g., two to eight, restraints per side of the build plate. The restraints 218 can be composed of material with sufficient strength to withstand the restraining force, e.g., a metal.

Each restraint 218 can be provided by a rod 228, e.g., a tie rod, that has a first end 222 secured to the build plate 104 and a second end that extends into or through the support structure 206. The clamping force can be provided by a spring, e.g., a spring 226 that urges the bottom of the rod 228 downward and thus pulls the perimeter of the build plate 104 toward the support structure 206.

In some implementations, the side of the build plate 104 can have a plurality of grooves 220 configured to receive and secure the first end 222, e.g., a flanged end, within the grooves 220. The grooves 220 and the first ends 222 can be complementary shapes such that the first ends 222 fit within the grooves 220 to restrain the build plate 104 from shifting vertically along the z-axis. For example, as illustrated in FIG. 3, the first ends 222 can be T-shaped and configured to fit within T-shaped grooves 222. Each first end 222 can apply 500 lbs. to 5000 lbs. of downward force on the build plate 104.

Beneath the build plate assembly 200 can be springs 224. The springs 224 can be helical compression springs, wave springs, Belleville or disc springs, stacks that include a plurality of such springs, or other similar device configured to apply a spring deflection force to urge the first end 222, and accordingly, the perimeter portion of the build plate assembly 200, downward toward the support structure 206. One end of the springs 224 can be configured to contact a bottom surface of the build plate assembly 200. At another end of the springs 224 and on the rod 228 can be a fastener 225, e.g., a nut to fasten the springs 224 to the build plate assembly 200. The springs 224 can apply 500 lbs. to 5000 lbs. of upward force on the build plate 104. In some implementations, the fasteners 225 can be adjusted to increase or decrease the force applied by the springs 224. The rod 228 can pass through the support structure 206. A catch can be positioned at the lower end of the rod 228, and springs 226 can be positioned between and contacting a bottom surface of the support structure 206 and a top surface of the catch. The springs 226 can be helical compression springs, wave springs, Belleville or disc springs, stacks that include a plurality of such springs, or other similar device configured to apply a spring deflection force to urge the rods 228 downward and thus pull the perimeter portion of the build plate 104 toward the support structure 206. The springs 226 can apply 500 lbs. to 5000 lbs. of upward force on the support structure 206. The catch can be provided by a fastener 227 that is secured to the lower end of the rod 228, e.g., a nut that is screwed onto a threaded lower end of the rod 228, to hold the springs 226 against the support structure 206. In some implementations, the fasteners 227 can be adjusted to increase or decrease the force applied by the springs 226.

An advantage to the build plate assembly 200 is that the entire assembly can be disassembled, and each component can be replaced. A component can first be calibrated for use during elevated temperatures, and the calibration can be recorded. Then, replacement components can be calibrated to a previously recorded setting, thus reducing the need to recalibrate when a component is replaced. For example, the torque for each fastener 225, 227 can be measured a first time, and replacement fasteners 225, 227 can be calibrated according to the previous torque measurements.

### Conclusion

The controller and other computing devices part of systems described herein can be implemented in digital electronic circuitry, or in computer software, firmware, or hardware.

For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

A number of implementations have been described. Nevertheless, it will be understood that various modifications may be made. Accordingly, other implementations are within the scope of the claims.

What is claimed is:

1. A build plate assembly for an additive manufacturing apparatus comprising:
a build plate to support an object to be fabricated by successive delivery of a plurality of layers of powder;
a support structure beneath the build plate and separated from the build plate by one or more supports; and
a plurality of restraints securing an outer edge of the build plate to the support structure.

2. The assembly of claim 1, further comprising a heater assembly beneath the build plate.

3. The assembly of claim 2, wherein the heater assembly comprises a heater element situated between an upper heater plate and a lower heater plate.

4. The assembly of claim 1, further comprising a gutter.

5. The assembly of claim 1, wherein the one or more supports are situated in recesses that allow for movement due to thermal expansion of the build plate.

6. The assembly of claim 5, wherein one or more of the recesses limits movement due to thermal expansion along a single direction along an axis that passes through the center of the build plate.

7. The assembly of claim 1, wherein the restraints are rods with a first end situated to sit in a groove in the build plate.

8. The assembly of claim 7, wherein the first end is a flanged first end.

9. The assembly of claim 8, wherein the flanged first end is T-shaped.

10. The assembly of claim 7, wherein the first end and the grooves are complementary shapes.

11. The assembly of claim 1, wherein there are four to forty restrains along the edge of the build plate.

12. The assembly of claim 1, further comprising a first set of springs below the build plate.

13. The apparatus of claim 12, further comprising a first set of fasteners to fasten the first set of springs to the build plate.

14. The apparatus of claim 1, further comprising a second set of springs below the support structure.

15. The apparatus of claim 14, further comprising a second set of fasteners to fasten the second set of springs to the support structure.

16. A build plate assembly for an additive manufacturing apparatus comprising:
a build plate to support an object being fabricated by successive delivery of a plurality of layers of powder; and
a support structure beneath the build plate and separated from the build plate by a plurality of supports, wherein the plurality of supports are situated in a plurality of recesses, and wherein the plurality of recesses include one or more first recess each of which permits motion of an associated support along two perpendicular directions and a second recess that limits movement of an associated support to a single direction along an axis that passes through the center of the build plate.

17. The build plate assembly of claim 16, wherein the plurality of recesses includes a third recess that fixes an associated support.

18. The build plate assembly of claim 17, wherein the third recess is located at a center of the build plate.

19. The build plate assembly of claim 17, wherein the one or more first recess and the second recess plurality of recesses are located at substantially equal angular intervals around the first recess.

20. The build plate assembly of claim 16, wherein the one or more first recess comprise a plurality of first recesses.

21. An additive manufacturing system, comprising:
a build plate assembly including a build plate to support an object being fabricated, a support structure beneath the build plate and separated from the build plate by one or more supports, and a plurality of restraints securing an outer edge of the build plate to the support structure;
a dispenser to deliver a succession of layers of powder onto the build plate; and
an energy source to fuse a portion of an exposed layer of powder on the build plate.
